(19) United States
(12) Patent Application Publication
(10) Pub. No.: US 2010/0177079 A1
(43) Pub. Date: Jul. 15, 2010

(54) Active Device Array Substrates and Liquid Crystal Display Panels and Liquid Crystal Displays Thereof

(75) Inventors: Chih-Yung Hsieh, Tainan County (TW); Ming-Feng Hsieh, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CHI MEI OPTOELECTRONICS CORP., Tainan County (TW)

(21) Appl. No.: 12/683,226

(22) Filed: Jan. 6, 2010

(30) Foreign Application Priority Data
Jan. 9, 2009 (TW) 98100496

(51) Int. Cl. G09G 5/00; G02F 1/1343

(52) U.S. Cl. 345/208; 349/39

(57) ABSTRACT

Active device array substrates and liquid crystal display (LCD) panels and LCDs thereof are provided. In a representative device, a set of bias lines used for providing bias signals to storage capacitor of pixel units with a bright zone and a dark zone is provided on the active device array substrate.

### BACKGROUND

1. Technical Field

The disclosure relates to liquid crystal displays (LCDs).

2. Description of Related Art

Since thin film transistor liquid crystal displays (TFT-LCDs) typically exhibit advantages of high image quality, high space utilization efficiency, low power consumption, no radiation, etc., these displays have become popular in the market. Presently, desired performance requirements of an LCD in the market tends to involve high contrast ratio, fast response time and wide viewing angle, etc., and techniques for achieving the feature of wide viewing angle, including multi-domain vertically alignment (MVA), multi-domain horizontal alignment (MHA), twisted nematic plus wide viewing film (TN+film) and in-plane switching (IPS).

Though an MVA LCD can achieve an effect of wide viewing angle, an accompanying color washout phenomenon thereof can be unacceptable. The so-called color washout phenomenon refers to that when a user views an image displayed on the LCD from different viewing angles, the user can see the image with different color tones. For example, when the user views the image displayed on the LCD from a side viewing angle, the user may see a partial white image.

Presently, a method for solving the above color washout phenomenon is provided, by which each pixel unit in a display panel of the MVA LCD is divided into two areas with different light transmittances, wherein one area has a relatively high light transmittance (i.e. a bright zone), which is used for displaying colors with higher gray levels, and another area has a relatively low light transmittance (i.e. a dark zone), which is used for displaying colors with lower gray levels. In this way, after the color with the higher gray level and the color with the lower gray level are blended to form a color with a middle gray level, the user can see a similar color image regardless of viewing the image displayed on the LCD from the front viewing angle or a side viewing angle.

FIG. 1 is a conventional equivalent circuit diagram illustrating several pixel units P of a display panel 100 used for solving the color washout phenomenon of the MVA LCD. Referring to FIG. 1, each of the pixel units P has two sub pixel areas Pa and Pb. Each sub pixel area Pa includes an active device TA, a liquid crystal capacitor C_{LC}(A) and a storage capacitor C_{ST}(A). Each sub pixel area Pb includes an active device TB, a liquid crystal capacitor C_{LC}(B) and a storage capacitor C_{ST}(B). Since a capacitor ratio of the storage capacitor C_{ST}(A) and the liquid crystal capacitor C_{LC}(A) in the sub pixel area Pa is not equal to a capacitor ratio of the storage capacitor C_{ST}(B) and the liquid crystal capacitor C_{LC}(B) in the sub pixel area Pb, i.e. C_{ST}(A)/C_{LC}(A) C_{ST}(B)/C_{LC}(B), the sub pixel area with relatively large capacitor ratio is the bright zone, and the sub pixel area with relatively small capacitor ratio is the dark zone.

On an active device array substrate (not shown) of the display panel 100 of the conventional MVA LCD, a layout pattern of bias lines Vst used for providing bias signals to the storage capacitors C_{ST}(A) and C_{ST}(B) of the sub pixel areas Pa and Pb can be generalized as exhibiting a horizontal layout pattern and a vertical layout pattern. When the layout pattern of the bias lines Vst arranged on the active device array substrate is the horizontal layout pattern, and a driving manner of the display panel 100 is a dot inversion or a column inversion, brightness presented by the pixel units P of odd/even columns in the display panel 100 is different.

Moreover, when the layout pattern of the bias lines Vst arranged on the active device array substrate is the horizontal layout pattern, and the driving manner of the display panel 100 is a row inversion, a horizontal crosstalk phenomenon known by those with ordinary skill in the art is generated, so that a display quality of the MVA LCD is decreased.

In contrast, when the layout pattern of the bias lines Vst arranged on the active device array substrate is the vertical layout pattern, a line width of the bias lines Vst is generally designed to be very slim to avoid influencing an aperture ratio of the pixel unit P, even though such design may increase a resistance-capacitance (RC) loading of the display panel.

Moreover, since thickness of a passivation layer between a metal layer and an indium tin oxide (ITO) layer used for fabricating the bias lines Vst typically is only 0.2 μm-0.3 μm, during a post fabrication process (for example, a polyimide (PI) processing and a hard baking processing) of the display panel 100, the bias line Vst may cause a short circuit between the metal layer and the ITO layer used for fabricating the bias lines Vst due to thermal expansion, so that a yield rate of the display panel 100 may be decreased.

### SUMMARY

Active device array substrates and liquid crystal display (LCD) panels and LCDs are provided. An exemplary embodiment of an active device array substrate comprises a first scan line, a first and a second data lines, a first and a second pixels, and a first and a second sub bias lines. The first scan line is formed on the active device array substrate along a first direction, and the first and the second data lines are formed on the active device array substrate along a second direction, wherein the first direction is perpendicular to the second direction. Moreover, the first and the second sub bias lines are formed on the active device array substrate substantially along the first direction.

The first pixel is disposed at a junction of the first scan line and the first data line, and has a first and a second sub pixels, wherein the first and the second sub pixels are respectively a bright zone and a dark zone. The second pixel is disposed at a junction of the first scan line and the second data line, and has a third and a fourth sub pixels, wherein the third and the fourth sub pixels are respectively the bright zone and the dark zone.

The first, the second, the third and the fourth sub pixels respectively comprise a first active device, a first pixel electrode and a first storage capacitor. Wherein, gates and drains of the first active devices of the first and the second sub pixels are respectively coupled to the first scan line and the first data line, and gates and drains of the first active devices of the third and the fourth sub pixels are respectively coupled to the first scan line and the second data line, and sources of the first active devices of the first, the second, the third and the fourth sub pixels are all coupled to the first pixel electrodes. Moreover, the first storage capacitors of the first and the second sub pixels are correspondingly formed between the first pixel electrodes and the first sub bias line, and the first storage capacitors of the third and the fourth sub pixels are correspondingly formed between the first pixel electrodes and the second sub bias line.

Several exemplary embodiments accompanied with figures are described in detail below.

### BRIEF DESCRIPTION OF THE DRAWINGS

The accompanying drawings are included to provide a further understanding and are incorporated in and constitute a part of this specification. The drawings illustrate non-limiting embodiments of the invention.

FIG. 1 is a conventional equivalent circuit diagram illustrating several pixel units of a display panel used for solving a color washout phenomenon of a multi-domain vertically alignment (MVA) liquid crystal display (LCD).

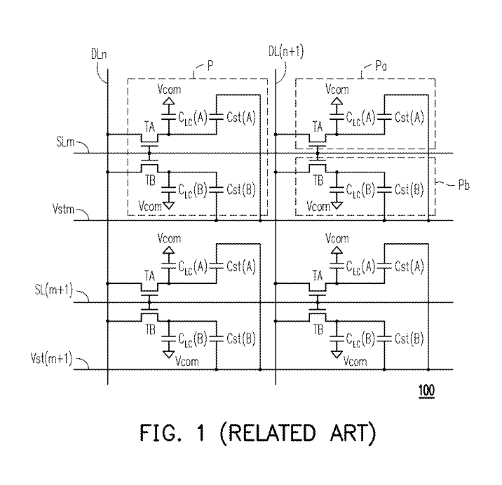

FIG. 2 is a block schematic diagram illustrating an exemplary embodiment of an LCD.

FIG. 3 is a block schematic diagram illustrating another exemplary embodiment of an LCD.

FIG. 4 is a block schematic diagram illustrating another exemplary embodiment of an LCD.

### DESCRIPTION OF THE EMBODIMENTS

Reference will now be made in detail to several preferred embodiments, which are illustrated in the accompanying drawings. Wherever possible, the same reference numbers are used in the drawings and the description to refer to the same or like parts.

In this regard, a technical function is used, in some embodiments, to resolve a plurality of problems generated when the convention bias lines used for providing bias signals to storage capacitors of pixel units having a bright zone and a dark zone are arranged on an active device array substrate in a horizontal layout pattern, so as to improve a display quality of a liquid crystal display (LCD). Notably, in some embodiments, a set of bias lines used for providing bias signals to storage capacitors of pixel units having a bright zone and a dark zone is added to an active device array substrate, so that when a layout pattern of the bias lines arranged on the active device array substrate is a horizontal layout pattern, regardless that a driving manner of the LCD panel is a dot inversion, a column inversion, or a row inversion, a display quality of the LCD is not decreased.

In an embodiment of the present invention, the first, the second, the third and the fourth sub pixels further respectively comprise a first stray capacitor, wherein the first stray capacitors of the first and the second sub pixels are correspondingly formed between the first pixel electrodes and the second sub bias line, and the first stray capacitors of the third and the fourth sub pixels are correspondingly formed between the first pixel electrodes and the first sub bias line.

In an embodiment of the present invention, the active device array substrate further comprises a second scan line, and a third and a fourth pixels. Wherein, the second scan line is formed on the active device array substrate along the first direction, the third pixel is disposed at a junction of the second scan line and the first data line, and has a fifth and a sixth sub pixels, wherein the fifth and the sixth sub pixels are respectively the bright zone and the dark zone. The fourth pixel is disposed at a junction of the second scan line and the second data line, and has a seventh and an eighth sub pixels, wherein the seventh and the eighth sub pixels are respectively the bright zone and the dark zone. Moreover, third and fourth sub bias lines are formed on the active device array substrate substantially along the first direction.

The fifth, the sixth, the seventh and the eighth sub pixels all comprises a second active device, a second pixel electrode and a second storage capacitor. Wherein, gates and drains of the second active devices of the fifth and the sixth sub pixels are respectively coupled to the second scan line and the first data line, and gates and drains of the second active devices of the seventh and the eighth sub pixels are respectively coupled to the second scan line and the second data line. Sources of the second active devices of the fifth, the sixth, the seventh and the eighth sub pixels are all coupled to the second pixel electrodes. The second storage capacitors of the fifth and the sixth sub pixels are correspondingly formed between the second pixel electrodes and the first sub bias line, and the second storage capacitors of the seventh and the eighth sub pixels are correspondingly formed between the second pixel electrodes and the second sub bias line.

In an embodiment of the present invention, the fifth, the sixth, the seventh and the eighth sub pixels further respectively comprise a second stray capacitor, wherein the second stray capacitors of the fifth and the sixth sub pixels are correspondingly formed between the second pixel electrodes and the second sub bias line, and the second stray capacitors of the seventh and the eighth sub pixels are correspondingly formed between the second pixel electrodes and the first sub bias line.

In an embodiment of the present invention, the active device array substrate further comprises a first total bias line and a second total bias line. Wherein, the first total bias line is formed on the active device array substrate along the second direction, and is coupled to the first and the third sub bias lines. The second total bias line is formed on the active device array substrate along the second direction, and is coupled to the second and the fourth sub bias lines.

In an embodiment of the present invention, the first total bias line is used for receiving a first bias signal and transmitting the first bias signal to the first and the third sub bias line, and the second total bias line is used for receiving a second bias signal and transmitting the second bias signal to the second and the fourth sub bias line. Wherein, amplitudes and frequencies of the first bias signal and the second bias signal are respectively the same, though phase differences therebetween are 180 degrees. The frequencies of the first and the second bias signals are the same to a frequency for a source driver transmitting a data signal to the first and the second data lines.

In an embodiment of the present invention, the first and the third sub bias lines are used for receiving a first bias signal, and the second and the fourth sub bias lines are used for receiving a second bias signal. Wherein, amplitudes and frequencies of the first bias signal and the second bias signal are respectively the same, though phase differences therebetween are 180 degrees. The frequencies of the first and the second bias signals are the same to a frame rate of the LCD.

The present invention provides an LCD panel comprising the aforementioned active device array substrate, an opposite substrate and a liquid crystal layer. Wherein, the opposite substrate has a common electrode, and the liquid crystal layer is disposed between the active device array substrate and the opposite substrate. Therefore, the aforementioned first, the second, the third and the fourth sub pixels further respectively comprises a first liquid crystal capacitor, wherein the first liquid crystal capacitors of the first, the second, the third and the fourth sub pixels are correspondingly formed between the first pixel electrodes and the common electrode, and the aforementioned fifth, the sixth, the seventh and the eighth sub pixels further respectively comprise a second liquid crystal capacitor, and the second liquid crystal capacitors of the fifth, the sixth, the seventh and the eighth sub pixels are correspondingly formed between the second pixel electrodes and the common electrode.

The present invention provides an LCD comprising the aforementioned LCD panel and a backlight module. Wherein, the backlight module is disposed under the LCD panel for providing a planar light source required by the LCD panel.

In an embodiment of the present invention, in case that the active device array substrate has the first total bias line and the second total bias line, the LCD further comprises a gate driver, a source driver and a bias signal generating unit. Wherein, the gate driver has a first and a second gate line. The gate driver uses the first and the second gate lines to sequentially output a scan signal to the first and the second scan lines according to a basic clock, so as to sequentially activate the first, the second, the third and the fourth pixels coupled to the first and the second scan lines.

The source driver has a first and a second source lines respectively coupled to the first and the second data lines. The source driver is used for receiving video data, and using the first and the second source lines to respectively supply a data signal to the first, the second, the third and the fourth pixels activated by the gate driver. The bias signal generating unit is used for individually providing a first and a second bias signals to the first and the second total bias lines.

In another embodiment of the present invention, in case that the active device array substrate does not have the first total bias line and the second total bias line, the LCD further comprises a gate driver and a source driver. Wherein, the gate driver has a first and a second gate lines, and a first, a second, a third and a fourth bias lines. The gate driver uses the first and the second gate lines to sequentially output a scan signal to the first and the second scan lines according to a basic clock, so as to sequentially activate the first, the second, the third and the fourth pixels coupled to the first and the second scan lines.

Moreover, the gate driver also uses the first and the third bias lines to individually supply the first bias signal to the first and the third sub bias lines, and uses the second and the fourth bias lines to individually supply the second bias signal to the second and the fourth sub bias lines according to the basic clock.

The source driver has a first and a second source lines respectively coupled to the first and the second data lines. The source driver is used for receiving video data, and using the first and the second source lines to respectively supply a data signal to the first, the second, the third and the fourth pixels activated by the gate driver.

In an embodiment of the present invention, in case that the active device array substrate does not have the first total bias line and the second total bias line, the LCD further comprises a gate driver and a source driver. Wherein, the gate driver has a first and a second gate lines, and a first, a second and a third bias lines. The gate driver uses the first and the second gate lines to sequentially output a scan signal to the first and the second scan lines according to a basic clock, so as to sequentially activate the first, the second, the third and the fourth pixels coupled to the first and the second scan lines.

Moreover, the gate driver also uses the first bias line to supply the first bias signal to the first sub bias line, uses the second bias line to supply the second bias signal to the second and the fourth sub bias lines, and uses the third bias line to supply the first bias signal to the third sub bias line according to the basic clock.

The source driver has a first and a second source lines respectively coupled to the first and the second data lines. The source driver is used for receiving video data, and using the first and the second source lines to respectively supply a data signal to the first, the second, the third and the fourth pixels activated by the gate driver.

In the present invention, one set of bias lines used for providing the bias signals to the storage capacitors of the pixel units having the bright zone and the dark zone is added to the active device array substrate, and the two sets of bias lines individually receive the first bias signal and the second bias signal having a phase difference of 180 degrees, and then the first and the second bias signals are individually provided to the storage capacitors of the pixel units of odd columns and the storage capacitors of the pixel units of even columns in the LCD panel.

Therefore, when a layout pattern of the two sets of bias lines arranged on the active device array substrate is a horizontal layout pattern, and a driving manner of the LCD panel is a dot inversion or a column inversion, brightness presented by the pixel units of odd/even columns in the LCD panel are the same. Moreover, when the layout pattern of the two sets of bias lines arranged on the active device array substrate is the horizontal layout pattern, and the driving manner of the LCD panel is a row inversion, a horizontal crosstalk phenomenon is effectively eliminated, so that the display quality of the LCD can be greatly improved.

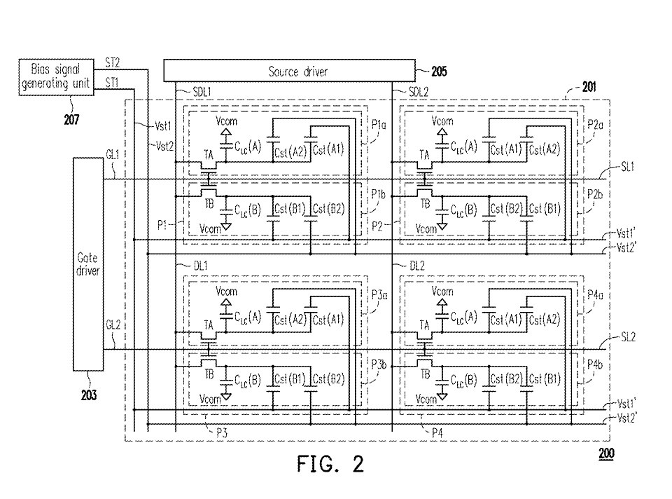

FIG. 2 is a block schematic diagram illustrating an exemplary embodiment of an LCD device 200. Referring to FIG. 2, the LCD 200 includes an LCD panel 201, a gate driver 203, a source driver 205 and a bias signal generating unit 207. In FIG. 2, equivalent circuits of an active device array substrate, an opposite substrate and a liquid crystal layer of the LCD panel 201 are illustrated, wherein only 4 pixel units P1-P4 are used for describing the active device array substrate, although various other configurations can be used in other embodiments. The opposite substrate has a common electrode Vcom, and the liquid crystal layer is disposed between the active device array substrate and the opposite substrate.

The active device array substrate includes a scan line SL1, a scan line SL2, a data line DL1, a data line DL2, pixels P1-P4, a sub bias line Vst1′, a sub bias line Vst2′, a total bias line Vst1 and a total bias line Vst2. The scan line SL1, the scan line SL2, the sub bias line Vst1′ and the sub bias line Vst2′ are formed on the active device array substrate along a horizontal direction, and the data line DL1, the data line DL2, the total bias line Vst1 and the total bias line Vst2 are formed on the active device array substrate along a vertical direction. The total bias line Vst1 is coupled to the sub bias line Vst1′, and the total bias line Vst2 is coupled to the sub bias line Vst2′.

The pixel P1 is disposed at a junction of the scan line SL1 and the data line DL1, and includes a sub pixel P1a and a sub pixel P1b, wherein the sub pixel P1a is a bright zone, and the sub pixel P1b is a dark zone. The pixel P2 is disposed at a junction of the scan line SL1 and the data line DL2, and includes a sub pixel P2a and a sub pixel P2b, wherein the sub pixel P2a is the bright zone, and the sub pixel P2b is the dark zone. The pixel P3 is disposed at a junction of the scan line SL2 and the data line DL1, and includes a sub pixel P3a and a sub pixel P3b, wherein the sub pixel P2a is the bright zone, and the sub pixel P3b is the dark zone. The pixel P4 is disposed at a junction of the scan line SL2 and the data line DL2, and includes a sub pixel P4a and a sub pixel P4b, wherein the sub pixel P4a is the bright zone, and the sub pixel P4b is the dark zone.

Each of the sub pixels P1a, P2a, P3a and P4a includes a corresponding active device TA, a pixel electrode (not shown), a liquid crystal capacitor C_{LC}(A), a storage capacitor Cst(A1) and a stray capacitor Cst(A2). Each of the sub pixels P1b, P2b, P3b and P4b includes a corresponding active device TB, a pixel electrode (not shown), a liquid crystal capacitor C_{LC}(B), a storage capacitor Cst(B1) and a stray capacitor Cst(B2). Gates and drains of the active devices TA and TB of the sub pixels P1a and P1b are respectively coupled to the scan line SL1 and the data line DL1, and gates and drains of the active devices TA and TB of the sub pixels P3a and P3b are respectively coupled to the scan line SL2 and the data line DL1.

In addition, gates and drains of the active devices TA and TB of the sub pixels P2a and P2b are respectively coupled to the scan line SL1 and the data line DL2, and gates and drains of the active devices TA and TB of the sub pixels P4a and P4b are respectively coupled to the scan line SL2 and the data line DL2. Moreover, sources of the active devices TA and TB of the sub pixels P1a, P1b, P2a, P2b, P3a, P3b, P4a and P4b are coupled to their respective pixel electrodes. The liquid crystal capacitors C_{LC}(A) and C_{LC}(B) are correspondingly formed between the common electrode Vcom and the respective pixel electrodes coupled to the sources of the active devices TA and TB of the sub pixels P1a, P1b, P2a, P2b, P3a, P3b, P4a and P4b.

Moreover, the storage capacitors Cst(A1) and Cst(B1) of the sub pixels P1a, P1b, P3a and P3b are correspondingly formed between the sub bias line Vst1′ and the respective pixel electrodes coupled to the sources of the active devices TA and TB of the sub pixels P1a, P1b, P3a and P3b. The stray capacitors Cst(A2) and Cst(B2) of the sub pixels P1a, P1b, P3a and P3b are correspondingly formed between the sub bias line Vst2′ and the respective pixel electrodes coupled to the sources of the active devices TA and TB of the sub pixels P1a, P1b, P3a and P3b.

The storage capacitors Cst(A1) and Cst(B1) of the sub pixels P2a, P2b, P4a and P4b are correspondingly formed between the sub bias line Vst2′ and the respective pixel electrodes coupled to the sources of the active devices TA and TB of the sub pixels P2a, P2b, P4a and P4b. The stray capacitors Cst(A2) and Cst(B2) of the sub pixels P2a, P2b, P4a and P4b are correspondingly formed between the sub bias line Vst1′ and the respective pixel electrodes coupled to the sources of the active devices TA and TB of the sub pixels P2a, P2b, P4a and P4b.

Referring to FIG. 2, the gate driver 203 has gate lines GL1 and GL2. The gate driver 203 uses the gate lines GL1 and GL2 to sequentially output a scan signal to the scan lines SL1 and SL2 according to a basic clock provided by a timing controller (T-con, not shown), so as to sequentially activate the pixels P1-P4 coupled to the scan lines SL1 and SL2.

The source driver 205 has source lines SDL1 and SDL2 respectively coupled to the data lines DL1 and DL2. The source driver 205 is used for receiving video data provide by the T-con, and uses the source lines SDL1 and SDL2 to respectively supply a data signal to the pixels P1-P4 activated by the gate driver 203. The bias signal generating unit 207 may be controlled by the T-con, and is used for individually providing bias signals ST1 and ST2 to the total bias lines Vst1 and Vst2. Amplitudes and frequencies of the bias signals ST1 and ST2 are respectively the same, though phase differences therebetween are 180 degrees. The frequencies of the bias signals ST1 and ST2 are the same as a frequency for the source driver 205 transmitting the data signal to the data lines DL1 and DL2.

According to the above descriptions, it should be understood that each of the storage capacitors Cst(A1) and Cst(B1) of the pixel units P1 and P3 of the same column in the LCD panel 201 can receive the bias signal ST1 through the total bias line Vst1 and the sub bias line Vst1′, and that each of the stray capacitors Cst(A2) and Cst(B2) of the pixel units P1 and P3 can receive the bias signal ST2 through the total bias line Vst2 and the sub bias line Vst2′. In addition, each of the storage capacitors Cst(A1) and Cst(B1) of the pixel units P2 and P4 of the same column in the LCD panel 201 can receive the bias signal ST2 through the total bias line Vst2 and the sub bias line Vst2′, and each of the stray capacitors Cst(A2) and Cst(B2) of the pixel units P2 and P4 can receive the bias signal ST1 through the total bias line Vst1 and the sub bias line Vst1′.

Therefore, when the LCD panel 201 drives the pixels units P1-P4 through a driving manner of a dot inversion, a column inversion or a row inversion, only a corresponding bias signal is required to be supplied to the pixel units with the same driving polarity. Namely, the bias signal with the positive driving polarity is supplied to the pixel units with the positive driving polarity, and the bias signal with the negative driving polarity is supplied to the pixel units with the negative driving polarity.

To be specific, when a layout pattern of the sub bias lines Vst1′ and Vst2′ arranged on the active device array substrate of this embodiment is a horizontal layout pattern, and the driving manner of the LCD panel 201 is dot inversion and/or column inversion, brightness presented by the pixel units of the odd/even columns in the LCD panel 201 are the same. Moreover, when the layout pattern of the sub bias lines Vst1′ and Vst2′ arranged on the active device array substrate is the horizontal layout pattern, and the driving manner of the LCD panel 201 is row inversion, a horizontal crosstalk phenomenon can be effectively eliminated, so that the display quality of the LCD 200 can be improved.

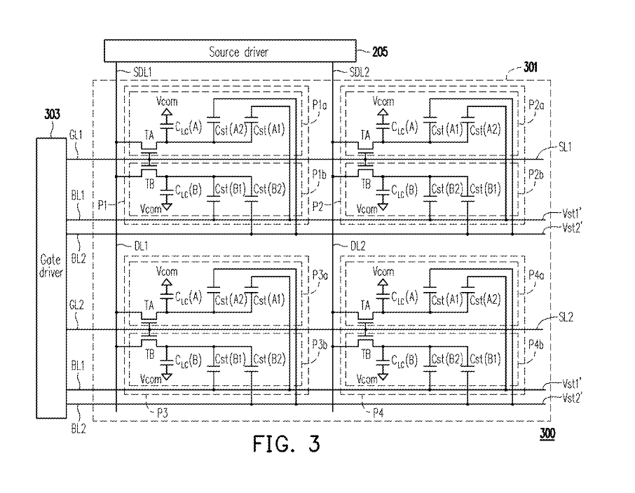

FIG. 3 is a block schematic diagram illustrating another exemplary embodiment of an LCD 300. Referring to FIG. 2 and FIG. 3, main differences between the LCD 300 and the LCD 200 are that the active device array substrate of the LCD panel 301 does not have the total bias lines Vst1 and Vst2, and bias lines BL1 and BL2 of the gate driver 303 are operative to provide the bias signals ST1 and ST2 having a phase difference of 180 degrees. Therefore, frequencies of the bias signal ST1 and ST2 are adjusted to be the same as a frame rate of the LCD 300, so that the LCD 300 can achieve potentially all of the technical functions achieved by the LCD 200 of the aforementioned embodiment.

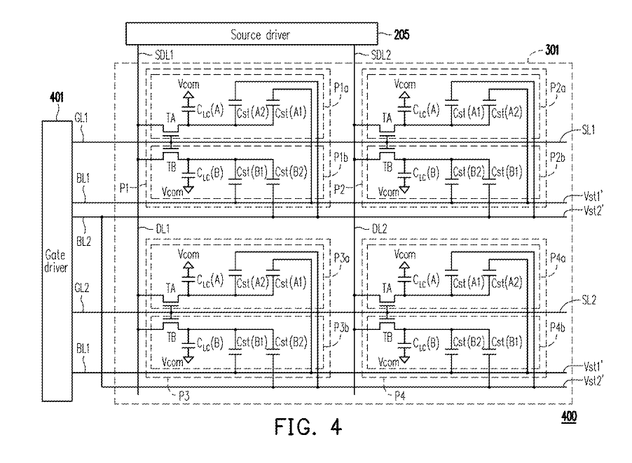

In addition, FIG. 4 is a block schematic diagram illustrating another embodiment of an LCD 400. Referring to FIGS. 2-4, a main difference between the LCD 400 and the LCD 300 is that the number of the bias lines (BL1 and BL2) of the gate driver 401 is less than the number of the bias lines of the gate driver 303. However, since the bias line BL2 of the gate driver 401 simultaneously provides the bias signal ST2 to two sub bias lines Vst2′, although the frequencies of the bias signals ST1 and ST2 can be also adjusted to be the same as a frame rate of the LCD 400, the bias signal ST2 falls behind the bias signal ST1 for a time period during which the source driver 205 transmits one data signal. Even so, the LCD 400 can still potentially achieve all of the technical functions achieved by the LCDs 200 and 300 of the aforementioned embodiments.

With respect to the embodiment of FIG. 4, in summary, one set of bias lines is used for providing the bias signals to the storage capacitors of the pixel units having the bright zone and the dark zone is added to the active device array substrate. The two sets of bias lines individually receive the first bias signal and the second bias signal having a phase difference of 180 degrees, and then the first and the second bias signals are individually provided to the storage capacitors of the pixel units of odd columns and the storage capacitors of the pixel units of even columns in the LCD panel.

Therefore, when a layout pattern of the two sets of bias lines arranged on the active device array substrate is the horizontal layout pattern, and the driving manner of the LCD panel is the dot inversion or the column inversion, brightness presented by the pixel units of odd/even columns in the LCD panel are the same. Moreover, when the layout pattern of the two sets of bias lines arranged on the active device array substrate is the horizontal layout pattern, and the driving manner of the LCD panel is the row inversion, a horizontal crosstalk phenomenon is effectively eliminated, so that the display quality of the LCD can potentially be substantially improved.

It will be apparent to those skilled in the art that various modifications and variations can be made to the various non-limiting, exemplary embodiments described above, with the scope of legal coverage afforded being commensurate with the scope of the following claims and their equivalents.

What is claimed is:

1. A liquid crystal display (LCD) device, comprising:
an active device array substrate comprising:
a first scan line, formed on the active device array substrate along a first direction;
a first and a second data lines, formed on the active device array substrate along a second direction, wherein the first direction is perpendicular to the second direction;
a first pixel, having a first and a second sub pixels, wherein the first and the second sub pixels are respectively a bright zone and a dark zone;
a second pixel, having a third and a fourth sub pixels, wherein the third and the fourth sub pixels are respectively the bright zone and the dark zone;
a first sub bias line, formed on the active device array substrate substantially along the first direction; and
a second sub bias line, formed on the active device array substrate substantially along the first direction,
wherein the first, the second, the third and the fourth sub pixels respectively comprise:
a first active device, wherein gates and drains of the first active devices of the first and the second sub pixels are respectively coupled to the first scan line and the first data line, and gates and drains of the first active devices of the third and the fourth sub pixels are respectively coupled to the first scan line and the second data line;
a first pixel electrode, wherein sources of the first active devices of the first, the second, the third and the fourth sub pixels are all coupled to the first pixel electrodes; and
a first storage capacitor, wherein the first storage capacitors of the first and the second sub pixels are correspondingly formed between the first pixel electrodes and the first sub bias line, and the first storage capacitors of the third and the fourth sub pixels are correspondingly formed between the first pixel electrodes and the second sub bias line.

2. The LCD device as claimed in claim 1, wherein the first, the second, the third and the fourth sub pixels further respectively comprise:
a first liquid crystal capacitor, wherein the first liquid crystal capacitors of the first, the second, the third and the fourth sub pixels are correspondingly formed between the first pixel electrodes and the common electrode.

3. The LCD device as claimed in claim 2, wherein the first, the second, the third and the fourth sub pixels further respectively comprise:
a first stray capacitor, wherein the first stray capacitors of the first and the second sub pixels are correspondingly formed between the first pixel electrodes and the second sub bias line, and the first stray capacitors of the third and the fourth sub pixels are correspondingly formed between the first pixel electrodes and the first sub bias line.

4. The LCD device as claimed in claim 3, wherein the active device array substrate further comprises:
a second scan line, formed on the active device array substrate along the first direction;
a third pixel, having a fifth and a sixth sub pixels, wherein the fifth and the sixth sub pixels are respectively the bright zone and the dark zone;
a fourth pixel, having a seventh and an eighth sub pixels, wherein the seventh and the eighth sub pixels are respectively the bright zone and the dark zone;
a third sub bias line, formed on the active device array substrate substantially along the first direction; and
a fourth sub bias line, formed on the active device array substrate substantially along the first direction,
wherein the fifth, the sixth, the seventh and the eighth sub pixels respectively comprises:
a second active device, wherein gates and drains of the second active devices of the fifth and the sixth sub pixels are respectively coupled to the second scan line and the first data line, and gates and drains of the second active devices of the seventh and the eighth sub pixels are respectively coupled to the second scan line and the second data line;
a second pixel electrode, wherein sources of the second active devices of the fifth, the sixth, the seventh and the eighth sub pixels are all coupled to the second pixel electrodes; and
a second storage capacitor, wherein the second storage capacitors of the fifth and the sixth sub pixels are correspondingly formed between the second pixel electrodes and the first sub bias line, and the second storage capacitors of the seventh and the eighth sub pixels are correspondingly formed between the second pixel electrodes and the second sub bias line.

5. The LCD device as claimed in claim 4, wherein the fifth, the sixth, the seventh and the eighth sub pixels further respectively comprise:
a second liquid crystal capacitor, wherein the second liquid crystal capacitors of the fifth, the sixth, the seventh and the eighth sub pixels are correspondingly formed between the second pixel electrodes and the common electrode.

6. The LCD device as claimed in claim 5, wherein the fifth, the sixth, the seventh and the eighth sub pixels further respectively comprise:
a second stray capacitor, wherein the second stray capacitors of the fifth and the sixth sub pixels are correspondingly formed between the second pixel electrodes and the second sub bias line, and the second stray capacitors of the seventh and the eighth sub pixels are correspondingly formed between the second pixel electrodes and the first sub bias line.

7. The LCD device as claimed in claim 5, wherein the active device array substrate further comprises:
a first total bias line, formed on the active device array substrate along the second direction, and coupled to the first and the third sub bias lines; and
a second total bias line, formed on the active device array substrate along the second direction, and coupled to the second and the fourth sub bias lines.

8. The LCD device as claimed in claim 7, wherein the first total bias line is used for receiving a first bias signal and transmitting the first bias signal to the first and the third sub bias line, and the second total bias line is used for receiving a second bias signal and transmitting the second bias signal to the second and the fourth sub bias line,
wherein amplitudes and frequencies of the first bias signal and the second bias signal are respectively the same, though phase differences therebetween are 180 degrees.

9. The LCD device as claimed in claim 8, further comprising:
a gate driver, coupled to the LCD panel, and having a first and a second gate lines, the gate driver using the first and the second gate lines to sequentially output a scan signal to the first and the second scan lines according to a basic clock, so as to sequentially activate the first, the second, the third and the fourth pixels coupled to the first and the second scan lines;
a source driver, coupled to the LCD panel, and having a first and a second source lines respectively coupled to the first and the second data lines, the source driver receiving video data, and using the first and the second source lines to respectively supply a data signal to the first, the second, the third and the fourth pixels activated by the gate driver; and
a bias signal generating unit, coupled to the LCD panel, for individually providing the first and the second bias signals to the first and the second total bias lines.

10. The LCD device as claimed in claim 9, wherein the frequencies of the first and the second bias signals are the same as a frequency for the source driver transmitting the data signal to the first and the second data lines.

11. The LCD device as claimed in claim 6, wherein the first and the third sub bias lines are used for receiving a first bias signal, and the second and the fourth bias lines are used for receiving a second bias signal,
wherein amplitudes and frequencies of the first bias signal and the second bias signal are respectively the same, though phase differences therebetween are 180 degrees.

12. The LCD device as claimed in claim 11, further comprising:
a gate driver, coupled to the LCD panel, and having a first and a second gate lines, and a first, a second, a third and a fourth bias lines, the gate driver using the first and the second gate lines to sequentially output a scan signal to the first and the second scan lines according to a basic clock, so as to sequentially activate the first, the second, the third and the fourth pixels coupled to the first and the second scan lines, and the gate driver using the first and the third bias lines to individually supply the first bias signal to the first and the third sub bias lines, and using the second and the fourth bias lines to individually supply the second bias signal to the second and the fourth sub bias lines according to the basic clock; and
a source driver, coupled to the LCD, and having a first and a second source lines respectively coupled to the first and the second data lines, the source driver receiving video data, and using the first and the second source lines to respectively supply a data signal to the first, the second, the third and the fourth pixels activated by the gate driver.

13. The LCD device as claimed in claim 12, wherein the frequencies of the first and the second bias signals are the same as a frame rate of the LCD.

14. The LCD device as claimed in claim 11, further comprising:
a gate driver, coupled to the LCD panel, and having a first and a second gate lines, and a first, a second and a third bias lines, the gate driver using the first and the second gate lines to sequentially output a scan signal to the first and the second scan lines according to a basic clock, so as to sequentially activate the first, the second, the third and the fourth pixels coupled to the first and the second scan lines, and the gate driver using the first bias line to supply the first bias signal to the first sub bias line, using the second bias line to supply the second bias signal to the second and the fourth sub bias lines, and using the third bias line to supply the first bias signal to the third sub bias line according to the basic clock; and
a source driver, coupled to the LCD panel, and having a first and a second source lines respectively coupled to the first and the second data lines, the source driver receiving video data, and using the first and the second source lines to respectively supply a data signal to the first, the second, the third and the fourth pixels activated by the gate driver.

15. The LCD device as claimed in claim 11, wherein the frequencies of the first and the second bias signals are the same as a frame rate of the LCD.

16. The LCD device as claimed in claim 1, wherein:
the LCD device is configured as an LCD panel;
the LCD device further comprises an opposite substrate and a liquid crystal layer;
the opposite substrate has a common electrode, and the liquid crystal layer is disposed between the active device array substrate and the opposite substrate.

17. The LCD device as claimed in claim 15, further comprising a backlight module, disposed under the LCD panel for providing a planar light source required by the LCD panel.
